(19) United States
(12) Patent Application Publication
(10) Pub. No.: US 2014/0017643 A1
(43) Pub. Date: Jan. 16, 2014

(54) SOFTWARE & CELLPHONE USE TO ANALYZE MEDICAL AND PSYCHOLOGICAL CONDITIONS

(71) Applicant: BRIAN SADY, LAS VEGAS, NV (US)

(72) Inventor: BRIAN SADY, LAS VEGAS, NV (US)

(21) Appl. No.: 13/400,305

(22) Filed: Jul. 16, 2012

(51) Int. Cl. G09B 19/00

(52) U.S. Cl. 434/236

(57) ABSTRACT

A software program using manually inputted data and/or laboratory data to predict and display the user's emotional and mental state. This provides a mobile laboratory for the public aiding medical and psychological diagnoses and treatments. Users can then manage their thoughts and display their emotional state currently being experienced.

Supplemental versions will use sensory input from biometric sensors from cell phones equipped with sensory arrays measuring physical signs such as pulse rate, pupil size, blink counts, body heat, etc., enabling a physician to predict and diagnose a person's present emotional and physical condition.

Combining the use of biometric sensors in cell phones with other technology allows for virtual online physician/patient consultation with instantaneous results. The use of these technologies will provide predictability of risk of future diseases.

### SUPPLEMENT OF PROPOSED SOFTWARE PROGRAM

Web based application which allows users to manage their emotions and thoughts throughout the day in a positive manner, and rewarding the users for these behavioral changes. The program will measure the emotional state of each user on a daily, and in some cases an hourly, bases. Finally the program will gather data and analyze it. The program is envisioned to have its own full feature website, facebook app., Iphone and Android app.

This application will help the user to manage their negative and positive feelings throughout the day. It accomplishes this by releasing negative energy, and promoting positive energy and positive thinking. This program also promotes social networking by rewarding the user for implementing positive thoughts and strategies for others. The individual user will only be able to share positive thoughts and energies, and will be rewarded in the program for doing so. There will be a blogging system that will also encourage the users to create new events, promote mentorship amongst its users and allow people to exchange experiences and knowledge.

There will be analytics software in place that will be able to data mine and collect all user profile information and be able to correlate this into statistical data. This portion of the software will be easy to manipulate enabling the company to change the parameters of the search queries. This data will be used and available on the site.

### APPLICATION OF BIOMENTRIC SENSORS IN SOFTWARE PROGRAM

The use of biometric sensors in cell phones record both passive and invasive testing constitutes another utility claim. Present lab technology for testing blood and urine as well as thermal imaging and scanning technology can be combined with cell phones to make mobile individual and secure laboratories for the general population. The combining of the cell phone with these other technologies will also allow for virtual online physician consulting with patients with almost instantaneous results, which can be electronically sent over the web via a secure connection to a physician for further interpretation. The phone will also be able to run software that will analyze and display a report on the results. These physical tests as well as emotional state data will also be combined by the software and analyzed for more patterns that may be useful for diagnosing psychiatric conditions as well as medical conditions. At present there are many psychiatric conditions that have no available blood tests to aid in diagnosis. The cell phone will be combined with heat sensing technology such as Fleer which would help to locate vessels for arterial and venipuncture as well as organs. The cell phone can also be programmed and have sensors to analyze blood tests such as blood counts, tumor markers, troponin levels, Hs-CRP levels, glucose levels, chemistry panels that include renal function, pregnancy tests, TSH levels, urine tests for infection and blood, ETOH breath tests. The camera on the cell phone will be used to take photos of, and diagnose, conditions of the skin and inner eye.

Eventually the cell phone will be used to communicate with nanobots that will be injected, or orally taken in order to diagnose patient disease states. The use of these combined technologies will also allow for the prediction of risk for future disease states by analyzing individual genomes for genetic flaws and variations.

1. A program using data inputted by users which are collected by sensors in cell phones and other devices, to predict and display a user's emotional and mental state leading to predictability, diagnoses and reduction of future disease risks.
This is a unique program in that, unlike any other programs, it enables users to manage their negative and positive emotions and thoughts and rewards users for their positive behavioral changes.
There is a Blogging System that encourages the users to create new events, and promote mentorship among its users and allows individuals to exchange experiences and knowledge.
The program combines an assortment of technologies creating online consulting between physician and patient with virtually instantaneous results transmitted electronically over the web via a secure connection to a physician for further interpretation of data. Current similar programs do not have available data that is offered by this program to aid in instantaneous and accurate emotional diagnoses and predictions in such an array of potential emotional maladies.
The program combines with other technologies, such as Fleer, assisting in the location of vessels for arterial, venipuncture and organs. Sensors are used to analyze blood tests such as blood counts, tumor markers, troponin levels, HS-CRP levels, urine tests for infection and blood, ETOH breath tests.
Cell Phone cameras are used to take photos of, and diagnose, conditions of the skin and inner eye.
